(19) United States
(12) Patent Application Publication
(10) Pub. No.: US 2025/0104378 A1
(43) Pub. Date: Mar. 27, 2025

(54) WINDOW FOG DETECTION DEVICE

(71) Applicant: TOYOTA JIDOSHA KABUSHIKI KAISHA, Toyota-shi (JP)

(72) Inventor: Taiki IIDA, Nisshin-shi (JP)

(73) Assignee: TOYOTA JIDOSHA KABUSHIKI KAISHA, Toyota-shi (JP)

(21) Appl. No.: 18/645,609

(22) Filed: Apr. 25, 2024

(30) Foreign Application Priority Data
Sep. 27, 2023 (JP) 2023-166162

(51) Int. Cl. G06V 10/22; G06V 20/56

(52) U.S. Cl. CPC G06V 10/22; G06V 20/56

(57) ABSTRACT

A window fog detection device includes a fog determination unit. The fog determination unit is configured to determine a fogging state of a window of a vehicle by performing image processing on an image generated by a camera that captures an image of surroundings of the vehicle through the window. The fog determination unit limits an image region to be used to determine the fogging state so as to reduce a load of the image processing.

### CROSS-REFERENCE TO RELATED APPLICATION

This application claims priority to Japanese Patent Application No. 2023-166162 filed on Sep. 27, 2023, incorporated herein by reference in its entirety.

### BACKGROUND

### 1. Technical Field

The present disclosure relates to window fog detection devices.

### 2. Description of Related Art

Japanese Unexamined Patent Application Publication No. 2019-004254 (JP 2019-004254 A) describes determining a fogging state of a window of a vehicle based on an image generated by a camera that captures an image of the surroundings of the vehicle through the window.

### SUMMARY

However, performing image processing for determining a fogging state of a window tends to increase the overall processing load in a vehicle. This is remarkable when a camera image that is subjected to the image processing has a large number of pixels. Various controls for safe driving of a vehicle are performed in vehicles, and it is desired to reduce the load of such image processing from the viewpoint of preventing system failure, reducing power consumption, etc.

In view of the above problem, an object of the present disclosure is to reduce the load of image processing when detecting window fog of a vehicle based on a camera image.

The gist of the present disclosure is as follows.
(1) A window fog detection device includes a fog determination unit configured to determine a fogging state of a window of a vehicle by performing image processing on an image generated by a camera that captures an image of surroundings of the vehicle through the window.
   The fog determination unit limits an image region to be used to determine the fogging state so as to reduce a load of the image processing.
(2) In the window fog detection device according to (1), the limited image region may include a region near an end of the window.
(3) The window fog detection device according to (1) or (2) may further include
   a load calculation unit configured to calculate the load of the image processing.
   The fog determination unit may limit the image region to be used to determine the fogging state when the load of the image processing of an entire region of the image is greater than a predetermined threshold.
(4) In the window fog detection device according to (3),
   the fog determination unit may narrow the image region to be used to determine the fogging state as the load of the image processing of the entire region of the image increases.
(5) In the window fog detection device according to (1) or (2),
   the fog determination unit may switch the image region to be used to determine the fogging state between an entire region and a partial region.

According to the present disclosure, it is possible to reduce the load of image processing when detecting window fog of a vehicle based on a camera image.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing a part of a configuration of a vehicle provided with a window fog detection device according to an embodiment of the present disclosure;

FIG. 2 schematically shows the interior of a vehicle;

FIG. 3 is a functional diagram of a processor of an ECU;

FIG. 4 is a flow chart showing a control routine of a cloud detecting process; and

FIG. 5 is a diagram illustrating an example of control for switching an image region to be used to determine a fogging state between an entire region and a partial region.

### DETAILED DESCRIPTION OF EMBODIMENTS

Hereinafter, embodiments of the present disclosure will be described in detail with reference to the drawings. In the following description, the same reference numerals are given to the same constituent elements.

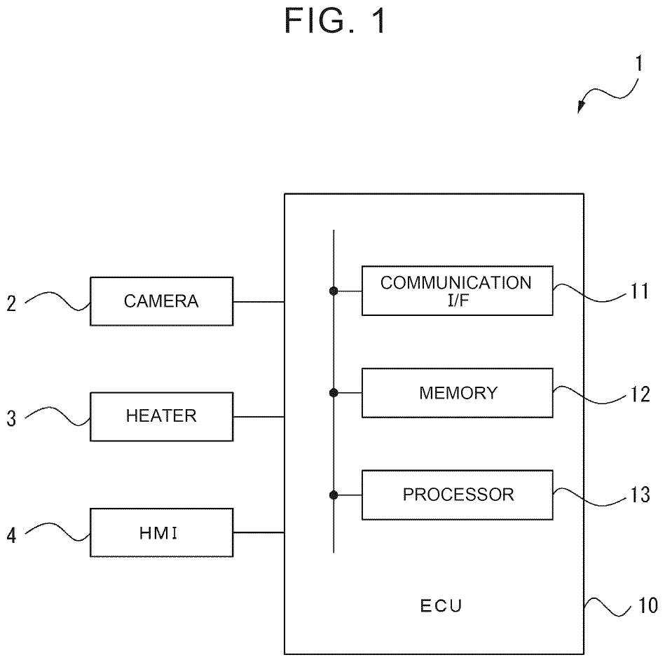

FIG. 1 is a diagram schematically illustrating a part of a configuration of a vehicle 1 provided with a window fog detection device according to an embodiment of the present disclosure.

As shown in FIG. 1, the vehicle 1 includes a camera 2, heaters 3, a human machine interface (HMI: Human Machine Interface) 4 and an electronic control unit (ECU: Electronic Control Unit) 10. The camera 2, the heater 3, and the HMI 4 are electrically connected to the ECU 10 via an in-vehicle network or the like compliant with standards such as CAN (Controller Area Network).

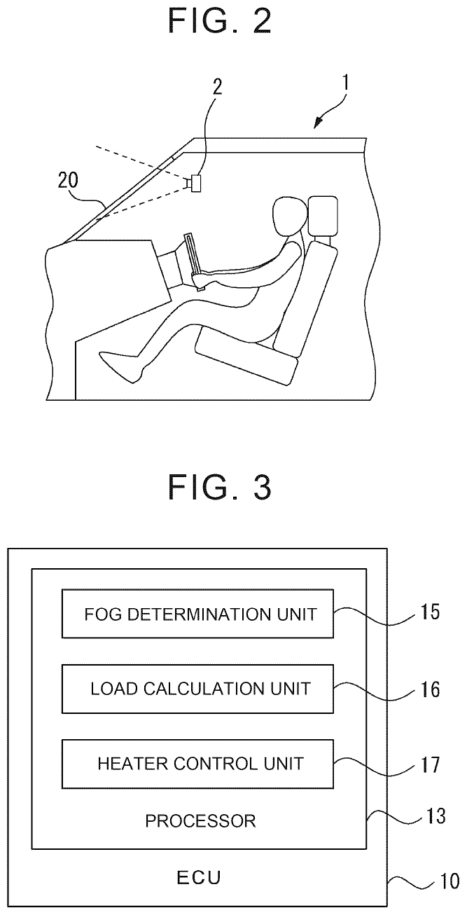

FIG. 2 is a diagram schematically illustrating the inside of the vehicle 1. As shown in FIG. 2, the camera 2 is provided inside the vehicle 1 (vehicle cabin), and captures an image of surroundings of the vehicle 1 through the window 20 of the vehicle 1. The camera 2 repeatedly captures an image of the surroundings of the vehicle 1 at predetermined capturing cycles (e.g., from 1/30 second to 1/10 second) to generate images. In the present embodiment, the camera 2 is a front camera that captures an image of an area in front of the vehicle 1, and the window 20 of the vehicle 1 located in the capturing range of the camera 2 is a front windshield. In this case, the camera 2 is disposed in front of the driver in the vehicle 1 (for example, the back surface of a rear view mirror, the inner surface of the front windshield, etc). The images generated by the camera 2 are sent to the ECU 10 and used, for example, for controlling a driving assistance function (a collision avoidance function, a lane departure prevention function, and the like) in the vehicle 1.

A heater 3 (not shown in FIG. 2) is provided in the window 20 of the vehicle 1 and heats the window 20. The heater 3 is, for example, a transparent thin-film member made of carbon nanotubes, and is a heating element that generates heat by energization. The heater 3 is disposed on or inside the window 20 of the vehicle 1. The heater 3 may be an electric heating wire disposed inside the window 20, a defroster that blows warm air to the window 20, etc. The ECU 10 controls the heaters 3.

The HMI 4 sends data between the vehicle 1 and the drivers of the vehicle 1. The HMI 4 includes an output unit (for example, a display, a speaker, a vibrating unit, or the like) that provides information to a driver of the vehicle 1, and an input unit (for example, a touch panel, an operation button, an operation switch, a microphone, or the like) to which information is input by the driver of the vehicle 1. The output of the ECU 10 is notified to the driver of the vehicle 1 via the HMI 4, and the input from the driver of the vehicle 1 is sent to the ECU 10 via the HMI 4.

The ECU 10 performs various controls of the vehicle 1. As shown in FIG. 1, the ECU 10 includes a communication interface 11, a memory 12, and a processor 13. The communication interface 11 and the memory 12 are connected to the processor 13 via a signal line. In the present embodiment, one ECU 10 is provided, but a plurality of ECUs may be provided for the individual functions.

The communication interface 11 has interface circuitry for connecting the ECU 10 to the in-vehicle networking. The ECU 10 is connected to other in-vehicle devices via the communication interface 11.

The memory 12 includes, for example, a volatile semiconductor memory and a non-volatile semiconductor memory. The memory 12 stores computer programs, data, and the like used when various kinds of processing are performed by the processor 13.

The processor 13 includes one or more central processing units (CPUs) and peripheral circuitry thereof. The processor 13 may further include other arithmetic circuits such as a logical arithmetic unit, a numerical arithmetic unit, or a graphic processing unit.

In the present embodiment, the ECU 10 functions as a window fog detection device that detects fog on the window 20 of the vehicle 1. Fog on the window 20 of the vehicle 1 is caused by dew condensation etc., and blocks the field of view of the driver of the vehicle 1.

FIG. 3 is a functional diagram of the processor 13 of the ECU 10. In the present embodiment, the processor 13 includes a fog determination unit 15, a load calculation unit 16, and a heater control unit 17. The fog determination unit 15, the load calculation unit 16, and the heater control unit 17 are functional modules realized by the processor 13 of the ECU 10 executing programs stored in the memory 12 of the ECU 10. These functional modules may be realized by dedicated arithmetic circuits provided in the processor 13.

As described above, the camera 2 captures an image of the surroundings of the vehicle 1 through the window 20 of the vehicle 1. That is, the imaging range of the camera 2 includes the window 20 of the vehicle 1. Therefore, when the window 20 of the vehicle 1 is fogged, an abnormality (e.g., whitening of an image) occurs in the image generated by the camera 2. Therefore, the fog determination unit 15 determines the fogging state of the window 20 by performing image processing on the image generated by the camera 2.

However, when the image processing for determining the fogging state of the window 20 is performed, the processing load on the entire vehicle 1 tends to increase. Therefore, in the present embodiment, the fog determination unit 15 limits the image region to be used to determine the fogging state of the window 20 so that the load of the image processing for determining the fogging state of the window 20 is reduced. That is, the fog determination unit 15 determines the fogging state of the window 20 by performing image 15 processing on a partial region of an image (hereinafter referred to as a “camera image”) generated by the camera 2. This can reduce the load of the image processing when detecting window fog of the vehicle 1 based on the camera image. For example, the fog determination unit 15 limits the image region used to determine the fogging state of the window 20 to the upper half, lower half, right half, left half, etc. of the camera image.

The load calculation unit 16 calculates the load of the image processing for determining the fogging state of the window 20. When the load of the image processing is low, it is less necessary to limit the image region to be used to determine the fogging state of the window 20 than when the load of the image processing is high. Therefore, in the present embodiment, the fog determination unit 15 limits the image region to be used to determine the fogging state of the window 20 when the load of the image processing of the entire region of the camera image is higher than a predetermined threshold. This suppresses the image region from being limited more than necessary, so that fog on the window 20 is less likely to be overlooked.

Incidentally, when the window 20 of the vehicle 1 is fogged, the window 20 typically starts being fogged from its ends (connection portion between the window 20 and the body of the vehicle 1). Based on this phenomenon, in the present embodiment, the image region limited by the fog determination unit 15 includes a region close to the ends of the window 20, and does not include a region far from the ends of the window 20. For example, when the upper half of the camera image is closer to any end of the window 20 (e.g., the connection portion between the front windshield and the roof of the vehicle 1) than the lower half of the camera image, the fog determination unit 15 limits the image region to be used to determine the fogging state of the window 20 to the upper half of the camera image. As a result, it is possible to reduce a decrease in detection accuracy of fog on the window 20 while reducing the load of the image processing.

The heater control unit 17 controls energization of the heater 3 and controls the operating state of the heater 3. When the fog determination unit 15 determines that the window 20 of the vehicle 1 is fogged, the heater control unit 17 supplies electric power to the heater 3 to operate the heater 3. The window 20 can thus be heated, so that the window 20 can be defogged.

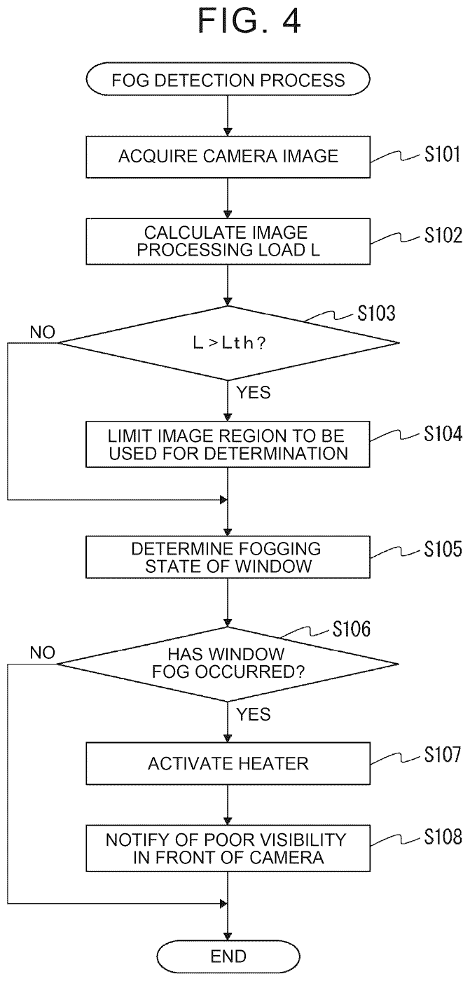

Hereinafter, a processing flow of the above control will be described with reference to FIG. 4. FIG. 4 is a flowchart illustrating a control routine of the fog detection process. This control routine is repeatedly executed by the processor 13 of the ECU 10 at predetermined intervals while the ignition switch of the vehicle 1 is turned on.

First, in S101, the fog determination unit 15 acquires camera-images.

Next, in S102, the load calculation unit 16 calculates the load L of the image processing of the entire region of the camera image. For example, the load calculation unit 16 calculates the load L of the image processing of the entire region of the camera image based on the number of pixels, brightness, contrast, etc. of the camera image. The load calculation unit 16 may calculate the load L of the image processing of the entire region of the camera image based on the number of targets recognized in the camera image (number of recognized targets), power consumption or usage of the processor 13 (e.g., an image processing chip), etc.

Next, the fog determination unit 15 determines in S103 whether the load L calculated by the load calculation unit 16 is higher than a predetermined threshold Lth. The threshold Lth is determined in advance as a value that requires a reduction in the process load due to the degeneracy control of the system. The threshold Lth may be changed according to the system load in the vehicle 1 (e.g., processor utilization of the ECU 10). In this case, the threshold Lth is reduced as the system load increases.

When it is determined that the load L is higher than the threshold Lth in S103, the present control routine proceeds to S104. In S104, the fog determination unit 15 limits an image region to be used to determine the fogging state of the window 20. For example, the fog determination unit 15 limits the image region to be used to determine the fogging state of the window 20 to the upper half of the camera image, the upper one third of the camera image, and the like. The fog determination unit 15 may narrow the image region to be used to determine the fogging state as the load L increases. As a result, it is possible to reduces variation in load of the image processing for determining the fogging state of the window 20. On the other hand, when it is determined in S103 that the load L is equal to or less than the threshold Lth, the control routine skips S104 and proceeds to S105.

In S105, the fog determination unit 15 determines the fogging state of the window 20 based on the camera image. When YES in S103, the fog determination unit 15 performs image processing on the image region limited in S104, that is, a partial region of the camera image. When NO in S103, the fog determination unit 15 performs image processing on the entire region of the camera image. For example, when a white region is detected in an image, the fog determination unit 15 determines that the window 20 is fogged. The fog determination unit 15 may determine the fogging state of the window 20 based on a plurality of successively captured camera images. In this case, the image region is limited for each of the camera images in S104.

Next, in S106, the heater control unit 17 determines whether the window 20 is fogged based on the determination by the fog determination unit 15. When it is determined that the window 20 is not fogged, the control routine ends. When it is determined that the window 20 is fogged, the control routine proceeds to S107.

In S107, the heater control unit 17 operates the heater 3 to heat the window 20 by the heater 3.

Next, in S108, the fog determination unit 15 notifies the driver of the vehicle 1 of poor visibility in front of the camera 2 via the HMI 4. After S108, the control routine ends.

S107 may be omitted, and in S108, the fog determination unit 15 may prompt the driver of the vehicle 1 to perform an operation of defogging the window 20 through the HMI 4.

While preferred embodiments of the present disclosure have been described above, the present disclosure is not limited to these embodiments, and various modifications and changes can be made within the scope of the claims. For example, the window of the vehicle 1 whose fogging state is to be determined may be a rear window, a side window, or the like.

In addition, the fog determination unit 15 may always determine the fogging state of the window 20 using a limited image region of the camera image. In this case, the fog determination unit 15 may change the position of the limited image region every time the fogging state is determined.

The fog determination unit 15 may temporarily limit the image region to be used to determine the fogging state regardless of the load of the image processing. That is, the fog determination unit 15 may switch the image region to be used to determine the fogging state between the entire region and a partial region. As a result, it is possible to reduce a decrease in detection accuracy of fog on the window 20 while reducing the load of the image processing.

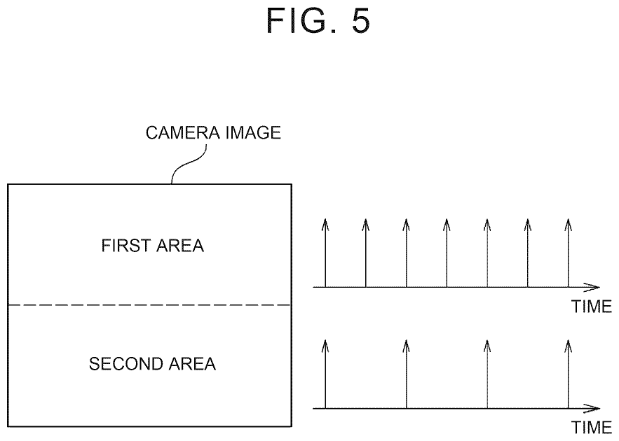

FIG. 5 is a diagram illustrating an example of such control. In FIG. 5, the upper arrow indicates the timing of determining the fogging state using a first area of the image region (upper half of the camera image), and the lower arrow indicates the timing of determining the fogging state using a second area of the image region (lower half of the camera image). The determination period of the first area is ½ of the determination period of the second area. At the timing when the upper arrow and the lower arrow overlap, the entire region of the camera image is used to determine the fogging state. In the example of FIG. 5, the fog determination unit 15 alternately switches the image region to be used to determine the fogging state between the entire region and a partial region.

The fog determination unit 15 may limit the image region to be used to determine the fogging state of the window 20 not only when determining the fogging state of the window 20 but also when determining defogging of the window 20 by the operation of the heater 3. In this case, for example, the fog determination unit 15 limits the image region to be used to determine defogging to a region far from the heater 3. That is, the image region limited by the fog determination unit 15 includes a region far from the heater 3 and does not include a region close to the heater 3. As a result, it is less likely to be determined that the window 20 has been defogged before the fog is completely removed from the window 20.

In addition, a computer program that causes a computer to realize the functions of the respective units included in the processor 13 of the ECU 10 may be provided in a form stored in a computer-readable recording medium. The computer-readable recording medium is, for example, a magnetic recording medium, an optical recording medium, or a semiconductor memory.

What is claimed is:

1. A window fog detection device comprising a fog determination unit configured to determine a fogging state of a window of a vehicle by performing image processing on an image generated by a camera that captures an image of surroundings of the vehicle through the window, wherein the fog determination unit limits an image region to be used to determine the fogging state so as to reduce a load of the image processing.

2. The window fog detection device according to claim 1, wherein the limited image region includes a region near an end of the window.

3. The window fog detection device according to claim 1, further comprising a load calculation unit configured to calculate the load of the image processing, wherein the fog determination unit limits the image region to be used to determine the fogging state when the load of the image processing of an entire region of the image is greater than a predetermined threshold.

4. The window fog detection device according to claim 3, wherein the fog determination unit narrows the image region to be used to determine the fogging state as the load of the image processing of the entire region of the image increases.

5. The window fog detection device according to claim 1, wherein the fog determination unit switches the image region to be used to determine the fogging state between an entire region and a partial region.
